(19) United States
(12) Patent Application Publication
(10) Pub. No.: US 2002/0011056 A1
(43) Pub. Date: Jan. 31, 2002

(54) Implement for treating a soil surface

(75) Inventors: Alexander van der Lely, Rotterdam (NL); Maarten Koorn, Schiedam (NL); Cornelis Franciscus Johannes Geerts, Moergestel (NL)

Correspondence Address: Penrose Lucas Albright, Esq., MASON, MASON & ALBRIGHT, P.O. Box 2246, Arlington, VA, 22202-0246, US

(73) Assignee: LELY ENTERPRISES AG, a SWISS LIMITED LIABILITY CO.

(21) Appl. No.: 09/911,406

(22) Filed: Jul. 25, 2001

(30) Foreign Application Priority Data
Jul. 25, 2000 (NL) 1015800

(51) Int. Cl. A01D 75/28

(52) U.S. Cl. 56/10.2 E; 56/10.2 F

(57) ABSTRACT

The invention relates to an implement for treating a soil surface, such as for example raking together grass and/or hay, said implement (1) being provided with a frame (2) comprising at least one, preferably motor-drivable, treating unit (3) provided with treating elements (8) for treating the soil surface. The implement (1) is provided with measuring means (13) which are suitable for feeling and/or scanning the soil surface to be treated and for determining ground irregularities, such as slopes and/or holes for example, that may be present in the soil surface, as well as with adjusting means (11) that adjust automatically the orientation and/or height of the treating unit (3) relative to the soil surface, on the basis of the measuring results of the measuring means (13).

The invention relates to an implement for treating a soil surface, such as for example raking together grass and/or hay, said implement being provided with a frame comprising at least one, preferably motor-drivable, treating unit provided with treating elements for treating the soil surface.

Such an implement is known.

It is an object of the invention to improve such an implement. In accordance with the invention this is achieved in that the implement is provided with measuring means which are suitable for feeling and/or scanning the soil surface to be treated and for determining ground irregularities, such as slopes and/or holes for example, that may be present in the soil surface, as well as with adjusting means that adjust automatically the orientation and/or height of the treating unit relative to the soil surface, on the basis of the measuring results of the measuring means. In the situation that the treating unit is designed as a rake for example, it is thus possible to realize good raking results, even in case of an uneven soil surface, due to the fact that the entire treating unit is optimally positioned. It will be obvious that, when the treating unit is constituted by an other agricultural implement, such as a mowing machine for example, this agricultural machine has similar advantages.

Instead of comprising measuring means, the implement may be provided, according to a further embodiment of the invention, with a storage medium which is suitable for storing data regarding the soil surface, in particular the irregularities in the soil surface to be treated, as well as with means for determining the position, such as DGPS for example, with the aid of which the current position of the treating unit is determined, and with adjusting means that adjust automatically the orientation and/or height of the treating unit relative to the soil surface, on the basis of the current position of the treating unit and the stored data regarding the soil surface at that place. Therefore, the invention also relates to an implement for treating a soil surface, such as raking together grass and/or hay for example, said implement being provided with a frame comprising at least one, preferably motor-drivable, treating unit provided with treating elements for treating a soil surface, characterized in that the implement is provided with a storage medium which is suitable for storing data regarding the soil surface, in particular the irregularities in the soil surface to be treated, as well as with means for determining the position, such as DGPS for example, with the aid of which the current position of the treating unit is determined, and with adjusting means that adjust automatically the orientation and/or height of the treating unit relative to the soil surface, on the basis of the current position of the treating unit and the stored data regarding the soil surface at that place. It will he obvious that it is also possible to combine the two implements according to the invention, so that the treating unit is adjusted on the basis of measurements carried out with the aid of the measuring means and on the basis of the data regarding the soil surface stored in the storage medium. It is further possible, if desired, to adjust data regarding the soil surface stored in the storage medium with the aid of data regarding the soil surface at that place obtained by the measuring means.

According to a further inventive feature, the measuring means comprise one or more sensors which, seen in the direction of travel of the implement, feel and/or scan the soil surface in front of the treating unit. According to again another inventive feature, the sensors are disposed on the frame. In a preferred embodiment of the invention, the sensors are designed as ultrasonic sensors. According to again another inventive feature, the sensors may comprise a camera. However, it will be obvious that also many other sensors than the sensors mentioned above may be applied. According to again another inventive feature, the adjusting means comprise control elements which are suitable for tilting the treating unit to the front respectively to the rear and/or laterally, seen in the direction of travel of the implement. According to another further inventive feature, for that purpose the adjusting means comprise at least one control element and preferably three control elements. Depending on the number of control elements the treating unit is capable of being tilted about one or more axes and thus being adjusted. According to another inventive feature it is further possible to adjust the treating unit in height relative to the soil surface. In the situation that three control elements are applied, it is possible to adjust the treating unit omnidirectionally relative to the soil surface. In a preferred embodiment of the invention the control elements are designed as control cylinders or stepper motors. For the purpose of realizing the above-mentioned tilting movement in a simple manner, according to the invention the adjusting means comprise one or more ball joints. According to again another aspect of the invention, the adjusting means comprise a clinometer which is suitable for determining the angle that is enclosed by the treating unit and the soil surface. According to again another aspect of the invention, the adjusting means comprise height measuring means which are suitable for determining the height assumed by the treating unit relative to the soil surface. According to another further inventive feature, the treating unit is designed as a motor-drivable rake. According to a further inventive feature, the rake comprises tine arms which are pivoted through a curve path. According to another inventive feature, the implement comprises a driving speed sensor. According to another further inventive feature, the implement comprises an rpm-sensor which is suitable for determining the number of revolutions of the treating unit and/or the treating element. With the aid of the driving speed sensor and the rpm-sensor it is possible, depending on the conditions of the surface to be treated, optimally to adjust the working depth of the treating unit and/or the treating element. With a rake or a tedder for example, at an unchanging number of revolutions of the treating unit and at an increased driving speed, it is possible to choose a deeper adjustment of the treating unit and/or the treating element.

The invention will now be explained in further detail with reference to the accompanying figures, in which

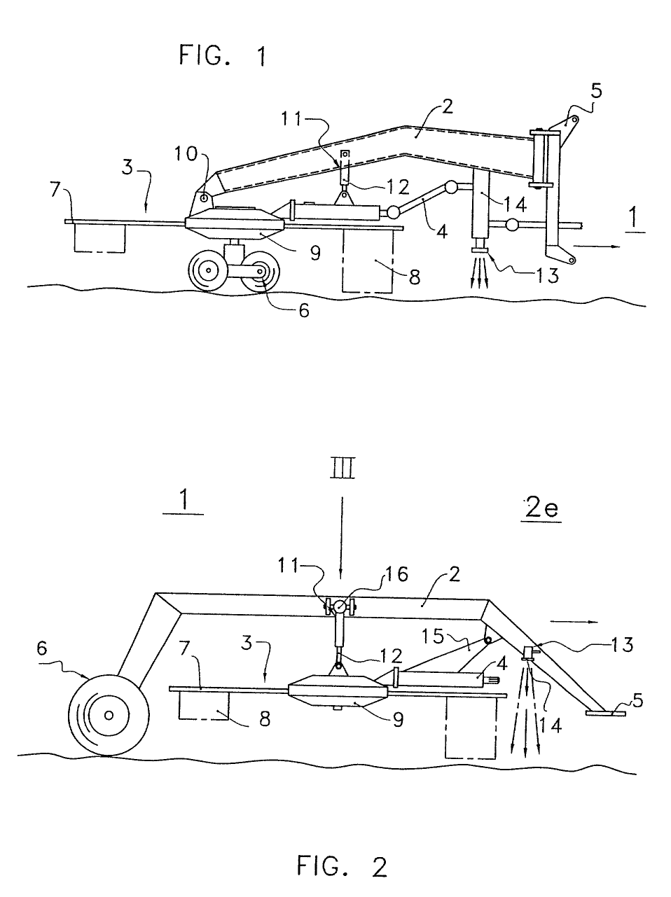

FIG. 1 is a side view of a first embodiment of an implement according to the invention;

FIG. 2 is a side view of a second embodiment of the implement according to the invention;

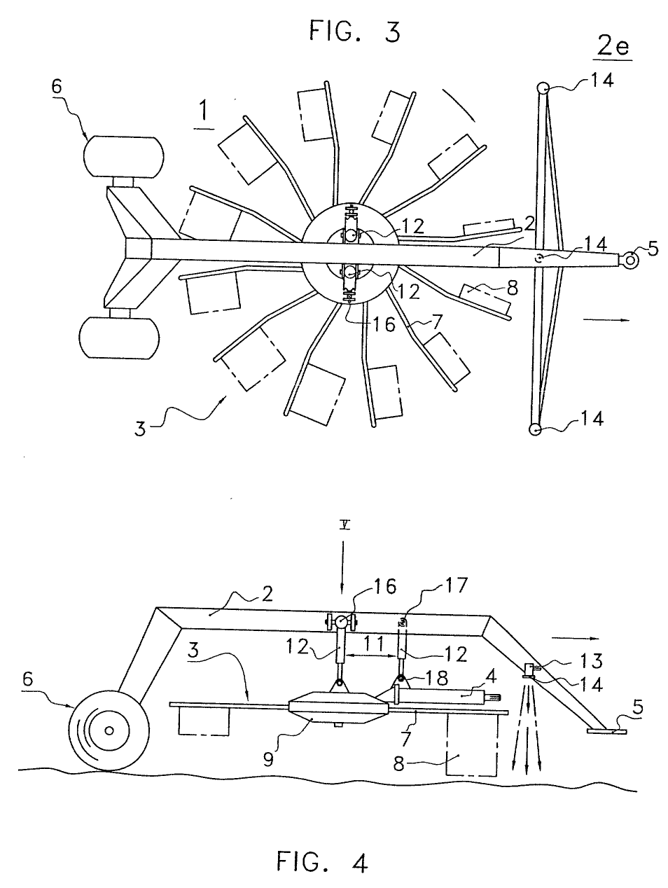

FIG. 3 is a plan view of the implement in FIG. 2 according to the arrow III in FIG. 2;

FIG. 4 is a side view of a third embodiment of the implement according to the invention, and

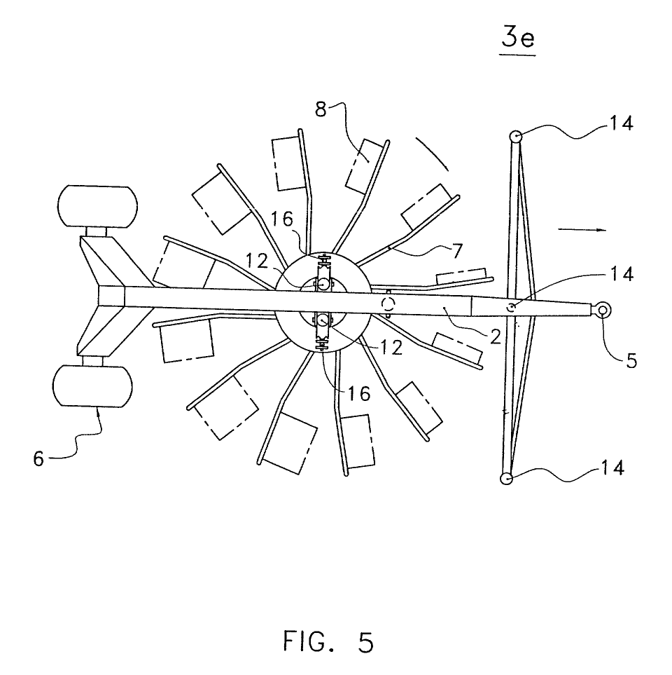

FIG. 5 is a plan view of the implement in FIG. 4 according to the arrow V in FIG. 4.

FIG. 1 is a side view of a first embodiment of an implement 1 according to the invention, said implement being provided with a frame 2 comprising a treating unit 3 which is designed as a rake in the present embodiment, The rake 3 is motor-drivable via a transmission 4. The frame 2 is further provided with coupling means 5 with the aid of which the implement can be coupled to a vehicle, such as a tractor for example. In the present embodiment the rake 3 is supported by a wheel set 6 that is designed as a tandem wheel set. The rake 3 is further provided with tine arms 7 having at their ends rake tines 8. The tine arms 7 are controlled via a central box 9 with a curve path therein. The central box 9 is connected with the frame 2 via a horizontal hinge pin 10. Between the frame 2 and the transmission 4 there are further provided adjusting means 11 with the aid of which the treating unit 3 can be adjusted relative to the soil surface by pivoting about the horizontal hinge pin 10. In the present embodiment the adjusting means 11 comprise a control cylinder 12 which is preferably designed as a servo-pneumatic control cylinder. The implement 1 is further provided with measuring means 13 which are suitable for feeling and/or scanning the soil surface to be treated and determining ground irregularities, such as slopes and/or holes for example, that may be present therein. The measuring means 13 comprise a plurality of sensors 14 which are disposed near the front side of the frame 2 and which are capable of feeling and/or scanning the soil at least over the full working width of the implement 1. When there is measured by the measuring means 13 a difference in height in the soil, the rake tines 8 of the rake 3 are adjusted with the aid of the adjusting means 11 in such a manner that the distance from the rake tines to the soil is maintained. In this way the rake tines are prevented from moving through the soil or extending far above the soil, so that they cannot take along grass or hay.

FIGS. 2 and 3 show a second embodiment of an implement according to the invention, in which parts corresponding to those in the first embodiment are indicated by the same reference numerals. In the second embodiment of the invention, unlike the first embodiment, not the treating unit 3, but the frame 2 is supported by a wheel set 6. In the present embodiment, seen in the direction of travel of the implement, the wheel set 6 is disposed after the treating unit 3. By means of a beam 15 the treating unit 3 is fitted to the frame 2 so as to be hingeable on a ball joint 16. Two control cylinders 12 are further provided between the central box 9 and the frame 2. The control cylinders 12 are also hingeably connected with the frame 2 by means of a ball joint 16. In the present embodiment the measuring means 13 comprise three sensors 14 with the aid of which ground irregularities, such as slopes and/or holes for example, can be determined. Due to the fact that the treating unit 3 is adjustable in height by means of the two control cylinders 12, the treating unit 3, seen in the direction of travel of the implement 1, can be tilted not only to the front and/or to the rear, but also laterally. In this manner it is possible to adjust even better the orientation and/or height of the rake tines 8 in relation to slopes (and/or holes) in the soil.

FIGS. 4 and 5 show a third embodiment of the implement according to the invention, in which parts corresponding to those in the first and second embodiment are indicated by the same reference numerals. The point in which the third embodiment differs most from the second embodiment is that the third suspension point of the treating unit 3 is not constituted by a beam 15, but by a control cylinder 12 which is connected with one end to the frame 2 by means of a horizontal hinge pin and which is connected with its other end to the transmission 4 by means of a horizontal hinge pin 18. Due to the fact that the treating unit 3 is connected with the frame 2 by means of three control cylinders 12 it is possible optimally to position the rake tines 8 of the treating unit 3 omnidirectionally relative to the frame 2, so that there can be achieved an excellent adjustment of the rake tines 8 to the soil in relation to slopes and/or holes therein.

1. An implement for treating a soil surface, such as for example raking together grass and/or hay, said implement (1) being provided with a frame (2) comprising at least one, preferably motor-drivable, treating unit (3) provided with treating elements (8) for treating the soil surface, characterized in that the implement (1) is provided with measuring means (13) which are suitable for feeling and/or scanning the soil surface to be treated and for determining ground irregularities, such as slopes and/or holes for example, that may be present in the soil surface, as well as with adjusting means (11) that adjust automatically the orientation and/or height of the treating unit (3) relative to the soil surface, on the basis of the measuring results of the measuring means (13).

2. An implement for treating a soil surface, such as for example raking together grass and/or hay, said implement (1) being provided with a frame (2) comprising at least one, preferably motor-drivable, treating unit (3) provided with treating elements (8) for treating the soil surface, characterized in that the implement (1) is provided with a storage medium which is suitable for storing data regarding the soil surface, in particular the irregularities in the soil surface to be treated, as well as with means for determining the position, such as DGPS for example, for determining the current position of the treating unit (3), and with adjusting means (11) that are suitable for automatically adjusting the orientation and/or height of the treating unit (3) relative to the soil surface, on the basis of the current position of the treating unit (3) and the stored data regarding the soil surface at that place.

3. An implement as claimed in claim 2, characterized in that the implement (1) is provided with measuring means (13) which are suitable for feeling and/or scanning the soil surface to be treated and for determining ground irregularities, such as slopes and/or holes for example, that may be present therein.

4. An implement as claimed in claim 1 or 3, characterized in that the measuring means (13) comprise one or more sensors (14) which, seen in the direction of travel of the implement (1), feel and/or scan the soil surface in front of the treating unit.

5. An implement as claimed in claim 4, characterized in that the sensors (14) are disposed on the frame (2).

6. An implement as claimed in claim 5, characterized in that the sensors (14) are designed as ultrasonic sensors.

7. An implement as claimed in claim 5, characterized in that the sensors (14) comprise a camera.

8. An implement as claimed in any one of the preceding claims, characterized in that the adjusting means (11) comprise control elements (12) which are suitable for tilting the treating unit (3) to the front respectively to the rear and/or laterally, seen in the direction of travel of the implement.

9. An implement as claimed in claim 8, characterized in that the adjusting means (11) comprise at least one control element and preferably three control elements (12).

10. An implement as claimed in claim 8 or 9, characterized in that the control elements (12) are designed as control cylinders or stepper motors.

11. An implement as claimed in any one of the preceding claims, characterized in that the treating unit (3) is adjustable in height relative to the soil surface.

12. An implement as claimed in claim 11, characterized in that the treating unit (3) is omnidirectionally adjustable relative to the height.

13. An implement as claimed in any one of the preceding claims, characterized in that the adjusting means (11) comprise a ball joint (16).

14. An implement as claimed in any one of the preceding claims, characterized in that the adjusting means (11) comprise a clinometer which is suitable for determining the angle enclosed by the treating unit (3) and the soil surface.

15. An implement as claimed in any one of the preceding claims, characterized in that the adjusting means (11) comprise height measuring means which are suitable for determining the height assumed by the treating unit (3) relative to the soil surfaces.

16. An implement as claimed in any one of the preceding claims, characterized in that the treating unit (3) is designed as a motor-drivable rake (3).

17. An implement as claimed in claim 16, characterized in that the rake comprises tine arms (7) which are pivoted through a curve path.

18. An implement as claimed in any one of the preceding claims, characterized in that the implement comprises a driving speed sensor.

19. An implement as claimed in any one of the preceding claims, characterized in that the implement comprises an rpm-sensor which is suitable for determining the number of revolutions of the treating unit and/or the treating element.
